(19) United States
(12) Patent Application Publication
(10) Pub. No.: US 2012/0316305 A1
(43) Pub. Date: Dec. 13, 2012

(54) ANTIMICROBIAL COMPOUNDS AND FIBERS THEREOF

(76) Inventors: Osama Esmail Bshena, Stellenbosch (ZA); Lubertus Klumperman, Leiderdorp (NL)

(21) Appl. No.: 13/576,996

(22) PCT Filed: Feb. 1, 2011
(86) PCT No.: PCT/IB11/00158

§ 371 Date: Aug. 3, 2012

(30) Foreign Application Priority Data
Feb. 4, 2010 (ZA) 2010/00813

(51) Int. Cl. C08F 122/40

(52) U.S. Cl. 526/262

(57) ABSTRACT

An antimicrobial polymer compound is provided having the formula (I) in which R is selected to provide acceptable characteristics to the compound. R is preferably selected from simple alkyl chains having from 1 to 15 carbon atoms and generally no more than 4 or 6 carbon atoms; tertiary amine groups having short chain alkyl groups with from 1 to 15 carbon atoms and generally no more than 4 or 6 carbon atoms; aromatic compounds having only one aromatic ring with one or more simple substituents such as hydroxide; and quaternary ammonium salts, preferably bromide or iodide, wherein the substituents are short chain alkyl groups with from 1 to 15 carbon atoms and generally no more than 4 or 6 carbon atoms. The antimicrobial polymer compound may be formed into fibers, especially nano fibers, and the fibers may be formed into filter elements especially for air or water.

### FIELD OF THE INVENTION

This invention relates to antimicrobial polymer compounds and especially, although not exclusively, to fibres and filter elements that are made of such antimicrobial compounds as well as to membranes and coatings made of such antimicrobial compounds.

### BACKGROUND TO THE INVENTION

Existing technology of which applicant is aware, adopts one of two different approaches to the provision of antimicrobial compounds. In a first, an antimicrobial compound is embodied in a fibrous polymer structure and leaches from the fibres in order to impart antimicrobial properties to the filter, membrane or coating.

In the second approach, the polymers themselves possess antimicrobial properties. Such polymers are, as far as applicant has been able to establish, all quaternary ammonium salts such as the well known example of 1-bromo-octane-based quaternary ammonium salt of poly(N,N-dimethylamino ethyl methacrylate).

### OBJECT OF THE INVENTION

It is an object of this invention to provide alternative polymer compounds that exhibit antimicrobial properties.

It is another object of the invention to provide polymer compounds that can be formed into fibres, in particular nano fibres, from which filter elements can be produced, or membranes, or coatings, or any two or all thereof.

### SUMMARY OF THE INVENTION

In accordance with one aspect of this invention there is provided an antimicrobial polymer compound having the formula

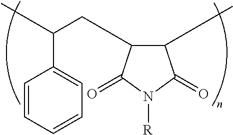

in which R is selected to provide acceptable characteristics to the compound.

A further feature of the invention provides for R to be selected from simple alkyl chains having from 1 to 15 carbon atoms and generally no more than 4 or 6 carbon atoms; tertiary amine groups having short chain alkyl groups with from 1 to 15 carbon atoms and generally no more than 4 or 6 carbon atoms; aromatic compounds having only one aromatic ring with one or more simple substituents such as hydroxide; and quaternary ammonium salts wherein the substituents are short chain alkyl groups with from 1 to 15 carbon atoms and generally no more than 4 or 6 carbon atoms, typically with bromide, chloride or iodide anions; with R most preferably having a formula selected from:—

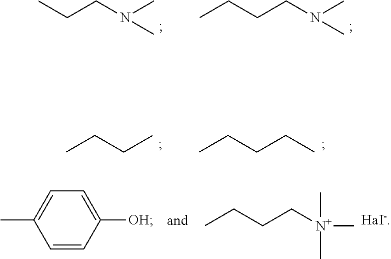

The most preferred substituents R at the time of filing this application are quaternary ammonium compounds in which the anion is bromine or iodine, phenol and tertiary amines.

The compounds may be classified as polystyrene-maleimide based copolymers.

In accordance with a second aspect of the invention there is provided a compound as defined above in the form of fibres.

Further features of this aspect of the invention provide for the fibres to be nano fibres; for the fibres to be formed by electro spinning; for electro spinning to be carried out by causing the fibres to form on a substrate, especially either by spinning the fibres onto a support such as a nylon support or by coaxial spinning with a suitable support material such as a suitable nylon; and for the fibres to be formed into an antimicrobial filter element for use in air or water purification.

In accordance with a third aspect of the invention a compound as defined above may be formed into a film for use as an antimicrobial membrane or coating.

The invention also provides a method of producing a compound as defined above comprising co-polymerising styrene and maleic anhydride to form styrene-maleic anhydride copolymer. The styrene-maleic anhydride copolymer may then be modified into the styrene-N-(N′,N′-dimethylaminopropyl)-maleimide either before or after the formation of any fibres or films of the compound.

In order that the invention may be more fully understood an expanded description thereof and various embodiments of the invention follows below with reference to the accompanying drawings.

### BRIEF DESCRIPTION OF THE DRAWINGS

In the drawings:—

FIG. 1 shows Fourier Transformation Infra Red (FTIR) spectra of (A) SMA, (B) anhydride ring opened product, and (C) SMI (styrene-dimethylaminopropylmaleimide)-P(50:50 styrene:maleic anhydride); and,

FIG. 2 is a schematic diagram of the electrospinning setup used to generate fibres from the copolymer produced.

### DETAILED DESCRIPTION AND EXAMPLES OF THE INVENTION

In order to prepare an intermediate styrene-maleic anhydride copolymer (SMA), 20 g, (mol) styrene and 18.78 g, (mol) of maleic anhydride were placed in a 500 ml three neck flask containing 250 ml methyl ethyl ketone (MEK) as solvent. 0.65 g azobisisobutyronitrile (AIBN) (1% mol based on monomers) was added to the flask with a nitrogen (N₂) stream flow.

After 15 minutes of purging, the flask was immersed in a preheated oil bath set by means of a temperature controller at a temperature of 60° C. The reaction was stopped after 15 hours and the copolymer was precipitated in methanol to yield ˜39g of styrene-maleic anhydride copolymer.

The number average molecular weight and polydispersity (PDI) were obtained using size exclusion chromatography (SEC). The results gave Mₙ=220,000 g/mol and PDI=3.9.

The chemical reaction of the polymerization was as follows:—

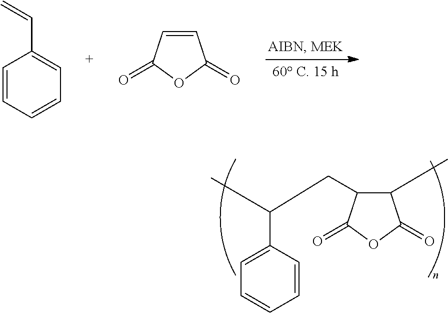

The corresponding styrene-dimethylaminopropylmaleimide (SMI) was then prepared by treating the intermediate styrene-maleic anhydride produced with 3-dimethylaminopropylamine (DMAPA).

15 g of styrene-maleic anhydride was placed in a 1 litre Erlenmeyer conical flask and 400 ml tetrahydrofuran (THF) was added to dissolve the copolymer. 30 ml of DMAPA was placed in a dropping funnel with 100 ml tetrahydrofuran. The DMAPA solution was added dropwise at room temperature over a period of 30 min and was then stirred for a further 2 hours. In this step the anhydride groups react rapidly with the free amine of DMAPA causing ring opening and forming the amide linkages according to the following reaction.

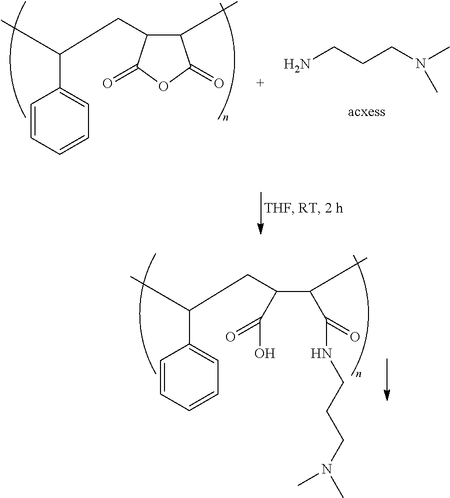

The white precipitate was filtered off; washed with pentane and dried under vacuum at 100° C. for 48 h to obtain the SMI yield of 17 g.

Alternatively, the SMI may be prepared by treating SMA with DMAPA in dimethylformamide (DMF) in a similar way to that carried out in THF.

After complete addition of DMAPA at 70° C., the polymer suspension was heated gradually bringing it to reflux. The suspension gradually cleared with increasing temperature and was refluxed for 2 hours. The solution was cooled and added to a bowl containing 300 ml of distilled water for precipitation. The pale precipitate was filtered off and dried at 50° C. under vacuum for 24 h.

In either event, the ring closure may be represented as follows:—

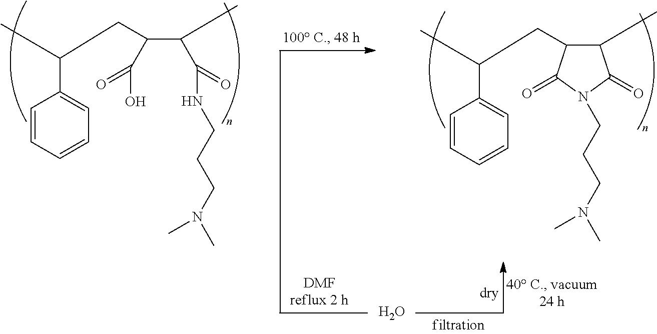

Polymer characterization:—

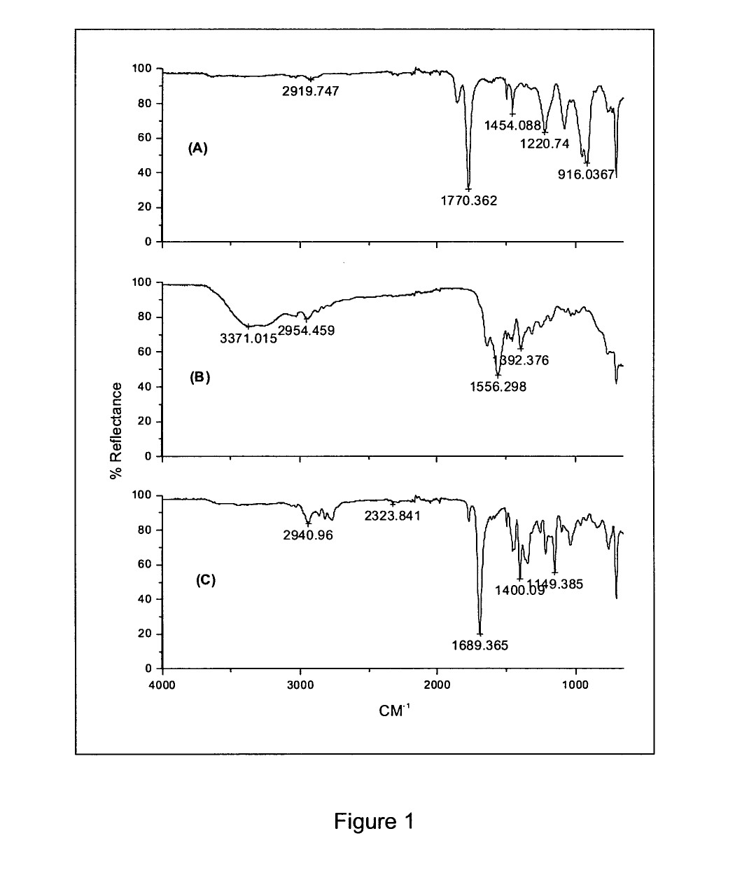

The modified polymers were analyzed by Attenuated Total Reflection Fourier Transform Infrared (ATR-FTIR) and Nuclear magnetic resonance (NMR) spectroscopy. An ATR-FTIR spectrum of SMI-P prepared from SMA is shown in the FIG. 1 of the drawings. The evidence of the characteristic absorption peaks of the C=O stretching imide was detected at 1689 cm⁻¹ which was shifted from an absorption of 1770 cm⁻¹ of the C=O stretching of the cyclic anhydride.

### Electrospinning of SMI-P

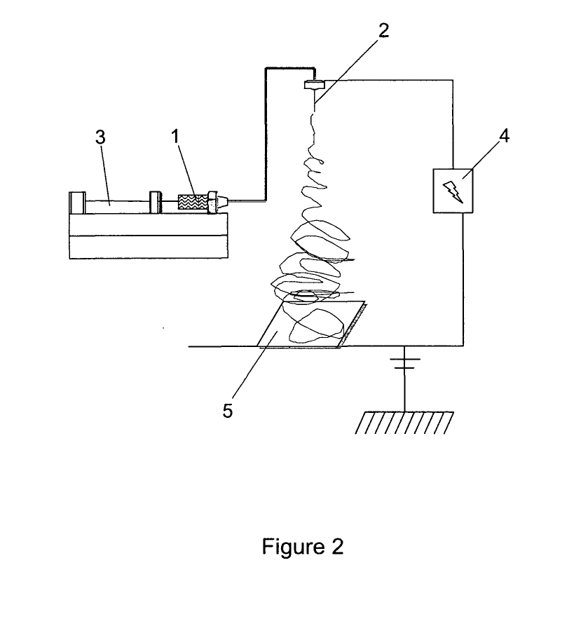

With reference to FIG. 2 of the drawings, a solution of 7-15% wt of SMI-P in absolute ethanol was prepared and transferred to a 5 ml syringe (1) for electrospinning. The polymer solution was poured into the 5 ml glass syringe that was equipped with a 26 gauge needle (2) (Hamilton), and an electrical control pump (3) (pump 33 Harvard Apparatus) was used to control the feed rate at 0.01-0.015 ml/min. A high-voltage power supply (4) was utilized to generate a potential difference of 10 kV between the needle and an aluminum foil grounded collector (5) at a distance of 15 cm from the tip of the needle.

Fiber morphology

The electro spun fibres were subjected to scanning electron microscopy (SEM) analysis for morphological assessments. This indicated that the fibres had an average diameter of ˜470 nm.

In one embodiment of the invention electrospun fibres were produced from copolymers having the structure shown above and the synthesized compound was used to form fibres that were evaluated for antimicrobial activity. The results indicate that the fibres possess good antibacterial activity against various bacterial strains especially against gram-positive strains, such as Staphylococcus aureus, Yersinia pestis amongst others as well against gram-negative strains. The compounds may therefore be effective against the diseases cholera, anthrax, and pestis.

Antimicrobial evaluation

The electrospun fibres were subjected to antimicrobial evaluation by testing their activity against different Gram-negative and Gram-positive bacterial strains including Pseudomonas aeruginosa, and Staphylococcus aureus. The strains used in the antimicrobial evaluation have a Photorhabdus luminescens lux ABCDE operon (lux gene) to provide bioluminescence. A Xenogen IVIS-200 Optical Imaging system was used as a tool to monitor the change in the bioluminescence intensity caused by the bacteria culture in the presence and absence of fiber contact.

Procedure: A pre-weighed fiber mat was placed together with a specific bacteria culture in a Petri dish and left at room temperature for several hours. During this period the sample was imaged using the IVIS system at different times starting from time zero. For example, the antimicrobial testing of the fibres was performed against the (Gram positive) Staphylococcus aureus strain code (Xen 36 from Bioware™ Microorganisms).

The results indicate that the fibres are active against S. Aureus. It appears that the fibres are somehow disrupting the bacterial cells causing reduction of bioluminescence intensity.

Observing the bioluminescent intensity of the material which corresponds to the bacteria status for each image over time, gave an indication of the viability of the bacteria cells, where high intensity refers a high number of cells present and vice versa. However, at this stage there is no solid evidence that the non bioluminescent culture is related to complete death or just inhibiting the bacteria cells, but still provides information on the effect of fiber contact with the bacterial culture compared to a fiber free sample.

To further confirm the anti-bacterial characteristic of the fibres, they were examined for antimicrobial activity in a bacteria growth media as follows:

A fiber sample was added to a test tube containing 10 ml BHI (brain heart infusion) medium. 100 μl of a pre-cultured media was added to the BHI solution that was then incubated at 37° C. A “control” tube containing no fiber was also incubated for comparison. As an antibacterial assessment, it was noted that the solutions were transparent in appearance with a light yellow colour.

After 5 hours of incubation, the control tube (fiber free) showed signs of significant cell growth because of opaqueness forming in the solution. This was strong evidence that the number of grown cells was already very high.

On the other hand, the solution was almost clear in the fiber containing tube. That indicated that the fibres were inhibiting the growth of cells. It should be noted that this experiment was carried out in triplicate and the findings were consistent in all tubes. The incubation was continued overnight and then dilutions were made and plated on agar plates to estimate the colony forming units per ml (CFU).

Also the optical density was measured at 600 nm to estimate the CFU/ml. It was found that 10⁸ cells were present for the control tube after 20 times dilution. The optical density for the fiber containing tube was also measured in the undiluted solution and found to be around the same number of cells, indicating that the fiber containing samples had 20 times less cells compared to that of the control. This is a very good indication that the fiber indeed has antimicrobial characteristics and was able to inhibit cell growth even in such an optimally nutritious growing environment for the bacteria.

### Evaluation using fluorescent microscopy

Fluorescent microscopy was used to investigate the mode of action of the fibres towards the bacteria cells. For this experiment two different dyes were utilized for cell viability. Propidium iodide was used for identifying dead cells (red light) in a population and as a counterstain against Hoechst that was used to stain live or fixed cells (emit blue light).

Experimentally, this was performed by placing a small piece of fiber in the stained diluted bacteria solution (S. aureus cells in FSO solution 0.85% NaCl) and incubating for 30 min. During incubation, fluorescent images were taken to monitor changes and the results were compared to a sample containing no fiber.

After 30 minutes the imaging results showed significant reduction of living cells. In fact, the effect was rapid, as red labeled fluorescent cells increased with time. The appearance of red labeled fluorescent cells is explained by propidium iodide uptake because all damaged cell membranes become permeable to propidium iodide which is thus an indication of cell death.

On the other hand fluorescent images of fiber free sample did not show any colour difference as the labeled cells imaged remained blue.

It is expected that a range of compounds having different groups R will be similarly antimicrobial although, as in the instance of all families of different compounds, some are inactive, some are partially active, and some are highly active against one or other different bacteria or other biological species.

Further tests were therefore carried out on a variety of different compounds according to the invention that were all prepared and electrospun into polymer fibers in the manner described above. The fiber compounds were evaluated against some or all of the bacterial strains Staphylococcus aureus (Gram positive), Erescheirea coli and Pseudomonas aeruginosa (Gram negative).

In the antimicrobial efficacy tests, the bacterial cultures were grown in nutrient solutions (brain heart infusion (BHI) for S. aureus, and Luria Bertani broth for P. aeruginosa, and E. coli) at 37° C. overnight. The cells were harvested in a centrifuge, and re-suspended in a sterile saline ˜0.9% (w/v) sodium chloride solution. The solution was further diluted in a stock bottle to approximately 10⁶ cells/milliliter estimated by optical density (OD) measurement at 600 nm against a blank silane solution.

The electrospun fiber mats of each polymer were tested in triplicate. Pieces of the fiber mats (25-26 mg) were placed in a sterile centrifuge tube and aliquots of 5 mL were added to each tube from the stock culture solution. A control culture without fiber was also treated in a similar way. After an incubation period of 24 hours at 37° C., 1 milliliter of the bacteria culture was taken from each tube and added to 9 milliliters of sterile saline. This 10⁻¹ dilution was further serially diluted down to 10⁻⁶. Aliquots (0.1 milliliter) of diluted samples were then spread, in triplicate, onto plates (petri dish) of nutrient Agar.

After incubation at 37° C. for 24 h, the plates were examined, the number of colony forming units (CFU) were counted manually, and the results, after multiplication by the dilution factor, were expressed as mean colony forming units per milliliter (CFU/milliliter). The results are as follows for the various compounds tested.

1. Compound identified as SMI-P derived from a copolymer made as described above with a 50% maleic anhydride and having the formula:—

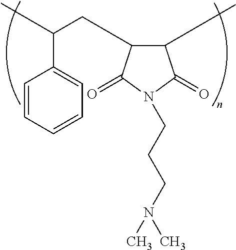

This compound had:—

5 log activity against S. Aureus;

No activity against P. aeruginosa; and

3 log activity against E. Coli.

2a. Compound identified as SMI-Pq1 derived from a copolymer made as described above with a 50% maleic anhydride and having the formula:—

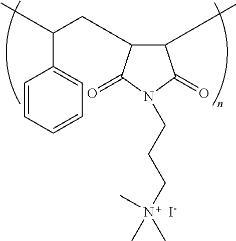

This compound had:—

6 log activity (total kill) against S. Aureus; and
5 log activity against E. Coli.

2b. The same compound identified as SMI-Cq1 was derived from a copolymer made from a commercially available SMA having only 28% maleic anhydride and had:—

3 log activity against S. Aureus; and
3 log activity against E. Coli.

3a. Compound identified as SMI-Pq4 derived from a copolymer made as described above with a 50% maleic anhydride and having the formula:—

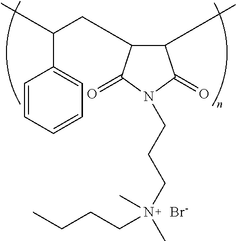

This compound had:—

6 log activity (total kill) against S. Aureus; and

6 log activity (total kill) against E. Coli.

3b. The same compound identified as SMI-Cq4 was derived from a copolymer made from a commercially available SMA having only 28% maleic anhydride and had:—

3 log activity against S. Aureus; and

2 log activity against E. Coli.

4a. Compound identified as SMI-Pq8 derived from a copolymer made as described above with a 50% maleic anhydride and having the formula:—

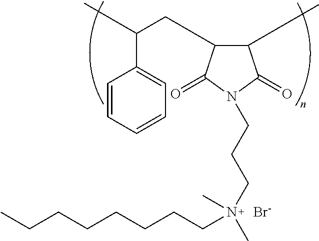

This compound had:—

6 log activity (total kill) against S. Aureus;

5 log activity (total kill) against P. aeruginosa; and

6 log activity (total kill) against E. Coli.

4b. The same compound identified as SMI-Cq8 was derived from a copolymer made from a commercially available SMA having only 28% maleic anhydride and had:—

3 log activity against S. Aureus; and

1 log activity against E. Coli.

5a. Compound identified as SMI-Pq12 derived from a copolymer made as described above with a 50% maleic anhydride and having the formula:—

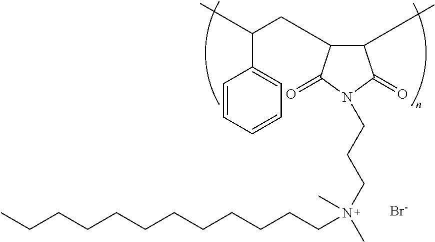

This compound had:—

6 log activity (total kill) against S. Aureus; and

6 log activity (total kill) against E. Coli.

5b. The same compound identified as SMI-Cq12 was derived from a copolymer made from a commercially available SMA having only 28% maleic anhydride and had:—

3 log activity against S. Aureus; and

1 log activity against E. Coli.

6. Compound identified as SMI-AP derived from a copolymer made as described above with a 50% maleic anhydride and having the formula:—

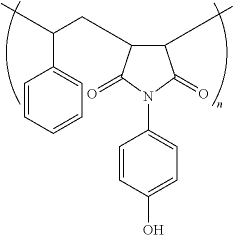

This compound had:—6 log activity (total kill) against S. Aureus; 3 log activity against P. aeruginosa; and 5 log activity against E. Coli.

7. Compound identified as SMI-NH derived from a copolymer made as described above with a 50% maleic anhydride and having the formula:—

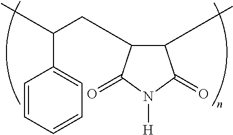

This compound had:—

No significant activity against S. Aureus; and

No significant activity against E. Coli.

8. Compound identified as SMI-NB derived from a copolymer made as described above with a 50% maleic anhydride and having the formula:—

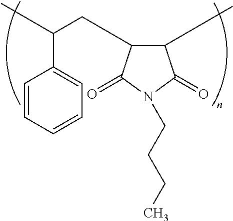

This compound had:—

No significant activity against S. Aureus;

No activity against P. aeruginosa; and

2 log activity against E. Coli.

9. Compound identified as SMI-AE derived from a copolymer made as described above with a 50% maleic anhydride and having the formula:—

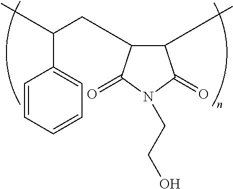

This compound had:—

No significant activity against S. Aureus;

No significant activity against E. Coli.

From the results illustrated above, it is clear that the polymer fibers of the quaternized type were the most potent for both Gram (−) and Gram (+) bacterial strains. The concentration of the fiber used in the antimicrobial evaluation is reasonably low (126-130 μg/millilitre), interesting and positive results were obtained for most of the fibers.

Functionalized fibers SMI-NH and SMI-AE did not show any significant activity against any of the tested strains.

SMI-NB fibers were slightly active against E. Coli.

5

SMI-P fibers showed good activity against S. aureous and moderate activity against E. Coli.

No significant bactericidal activity was detected for all unquaternized fibers against P. aeruginosa except for SMI-AP.

Selected compounds according to the invention may be effective against biological agents that may be used in warfare, biodefense, or terrorism. Such biological agents include viruses, bacteria, and their toxins, for example, bacterial threats/diseases such bacillus anthracis/anthrax, yersinia pestisi/plague, and V. cholerea/plague.

Fiber samples of SMI-P, were tested against bacillus anthracis, methecilin resistant S. aureous, yersinia pestisi and Vibrio Cholerae at the Netherlands Organization for Applied Scientific Research (TNO).

The tests were carried out in a similar manner to that described above with the fibers being treated with diluted overnight culture in a tube in. At time intervals 2, 4, 6, 24 and 48 hours, 0.1 ml was withdrawn and plated on agar plate for colony counts.

The results indicated that the fibers were able to inhibit the growth of all the strains as follows:—

3 log reduction after 24 hours and continued reduction (but no total kill after

71 hours in respect of methecilin resistant S. Aureous.

3 log reduction after 24 hours in respect of Vibrio Cholera.

6 log reduction (total kill) after 6 hours in respect of yersinia pestisi.

5 log reduction but not killed even after 76 hours in respect of bacillus anthracis.

No significant activity was noted against bacillus anthracis spores.

The cytotoxicity of the most potent compounds/fibers has been investigated to some extent and is currently still under evaluation. One of the methods is utilizing a fluorescent microscopy technique. In this method a visual inspection can determine the effect of the fibers when it comes to contact with mammalian cells by monitoring the fluorescent images as a function of time. In the initial trials, mammalian heart cells were used for the examination, in a similar way of that used for bacterial cells, PI and Hoechst dyes were used to stain the cells. Fibre samples of SMI-Pq1, SMI-Pq8, SMI-Pq12 were incubated with the cell culture and fluorescent imaging was carried out at different time points 5 min, 10 min, 30 min and 1 hour. The imaging results showed that the quarternized fibers containing the longest alkyl chain SMI-Pq12 were the least toxic to the cells within a one hour of contact with no indication of membrane damage being observed. Contrarily, the SMI-Pq1 fibres appeared to be toxic to the cells as noted by the PI (red light) uptake.

It will be understood that the invention is still under investigation and development and numerous different compounds need to be investigated in order to determine a suitably beneficial compound especially for application to is made of nano fibres.

1. An antimicrobial polymer compound having the formula 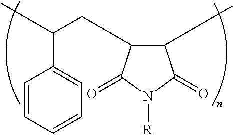
in which R is selected from simple alkyl chains having from 1 to 15 carbon atoms; tertiary amine groups having short chain alkyl groups with from 1 to 15 carbon atoms; aromatic compounds having only one aromatic ring with one or more simple substituents such as hydroxide; quaternary ammonium salts wherein the substituents are short chain alkyl groups with from 1 to 15 carbon atoms; and a formula selected from:—

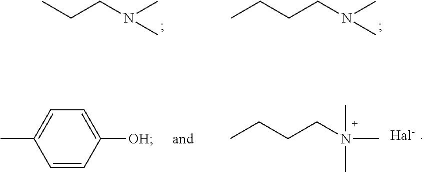

2. (canceled)

3. An antimicrobial polymer compound as claimed in claim 1 in which the simple alkyl chains and short chain alkyl groups each have from 1 to 6 carbon atoms.

4. An antimicrobial polymer compound as claimed in claim 1 in which R has a formula selected from:—

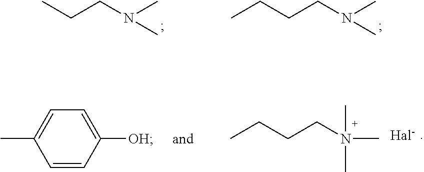

5. An antimicrobial polymer compound as claimed in claim 4 in which any quaternary ammonium salts are selected from chloride, bromide and iodide.

6. An antimicrobial polymer compound as claimed in claim 1 in which the compound is selected from those identified herein as SMI-P; SMI-Pq1; SMI-Pq4; SMI-Pq8; SMI-Pq12; and SMI-AP.

7. An antimicrobial polymer compound as claimed in claim 1 in the form of fibres.

8. An antimicrobial polymer compound as claimed in claim 7 in which the fibres are nano fibres.

9. An antimicrobial polymer compound as claimed in claim 8 in which the fibres are electrospun fibers.

10. An antimicrobial polymer compound as claimed in claim 8 in which the fibres are formed into an antimicrobial filter element for use in air or water purification.

11. An antimicrobial polymer compound as claimed in claim 1 in which the compound is formed into a film for use as an antimicrobial coating.

12. A method of producing an antimicrobial polymer compound having the formula 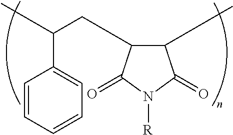
in which R is selected from simple alkyl chains having from 1 to 15 carbon atoms; tertiary amine groups having short chain alkyl groups with from 1 to 15 carbon atoms; aromatic compounds having only one aromatic ring with one or more simple substituents such as hydroxide; quaternary ammonium salts wherein the substituents are short chain alkyl groups with from 1 to 15 carbon atoms; and a formula selected from:— 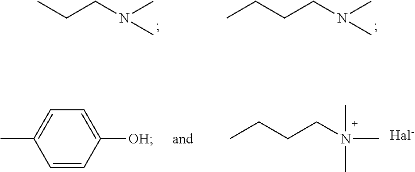
in which styrene and maleic anhydride are co-polymerised to form styrene-maleic anhydride copolymer that is subsequently modified into the styrene-N-(N′,N′-dimethylaminopropyl)-maleimide either before or after the formation of any fibres or films of the compound.

13. A method as claimed in claim 12 in which styrene and maleic anhydride are co-polymerized in substantially equal molar quantities.
